(19) United States
(12) Patent Application Publication
(10) Pub. No.: US 2014/0120347 A1
(43) Pub. Date: May 1, 2014

(54) Injection molded element and production method

(71) Applicant: Ditter Plastic GmbH + Co KG, Haslach i. K. (DE)

(72) Inventor: Burkhard Neumaier, Haslach i. K. (DE)

(73) Assignee: Ditter Plastic GmbH + Co KG, Haslach i. K. (DE)

(21) Appl. No.: 14/063,572

(22) Filed: Oct. 25, 2013

(30) Foreign Application Priority Data
Oct. 26, 2012 (DE) 102012110262.7

(51) Int. Cl. H01B 7/16; H01B 13/004

(52) U.S. Cl. CPC H01B 7/16; H01B 13/004
USPC 428/375; 264/279.1

(57) ABSTRACT

An injection molded element (1) made from plastic material from which one or plural electrical conductors (3) shall exit the electrical conductors are not directly encased when the injection molded element (1) is injection molded. Instead, an inner element (2) that has to be inserted into the injection mold first is prefabricated, for example also through injection molding, wherein the electrical conductors (3) are subsequently inserted into the inner element. The inner element (2) with the inserted conductors (3) is then inserted into the injection mold, wherein the inner element (2) protrudes at its faces beyond the injection molded element (1) enveloping it on the outside, so that the injection mold has to seal only relative to the outer circumference of the inner element (2) and not relative to the elastic electrical conductors (3) themselves.

### FIELD OF THE INVENTION

The invention relates to an injection molded element from which at least one electrical conductor is run out.

### TECHNICAL BACKGROUND OF THE INVENTION

In many applications it is necessary to provide an electrical power connection in an interior of an injection molded element and to run an electrical conductor from there out of the injection molded element or to run the electrical conductor through the injection molded element so that there are at least two outlet locations for the electrical conductor provided in the injection molded element.

Since typically not only one electrical conductor but two or more electrical conductors have to be run out, the individual electrical conductors are surrounded with the typical electric insulation made from plastic material which must not be damaged either since short circuits between the two or more electrical conductors can occur otherwise.

Since the injection molded element is typically made from plastic material and the raw material is injected at temperatures of, for example, 250° C. to 300° C., depending on its type, and the melting point of the plastic insulation of the electrical conductors is also in this temperature range or even below, there is a risk that the plastic insulations is heated up far enough when directly injection molding around the electrical conductors so that the insulation is rendered non-functional and the two metal electrical conductors get too close to one another or even contact one another.

Another problem when directly injection molding around the electrical conductor is that the electrical conductors have to be positioned in a defined manner within the injection mold so that the electrical conductors are not accidentally pressed against the edge of the injection mold and are then only enveloped by a very thin and not sufficiently protective layer of the injection molded element on one side. This is typically achieved through respective slides or protrusions in the injection mold which, however, generate cavities like e.g. dead holes in the injection molded elements which extend towards the electrical conductors.

Attempts have been made to prevent this by initially inserting the electrical conductors into a first injection mold and injection molding around them with an inner element that has a small cross section and inserting the inner element with the encased electrical conductors in a larger injection mold and encasing it with the actual injection molded element.

Thus, it can be assured that the electrical conductors are not arranged at an edge of the injection molded element, however, the problem of starting to melt the electrical insulation of the conductors is not solved.

An additional problem when directly encasing an electrical conductor which is run out of an injection molded element is sealing the outlet location of the electrical conductor from the injection mold during injection molding.

Since the insulating plastic jacket of the electrical conductor is elastic and also slightly compressible, the electrical conductor cannot be sealed tight enough at the outlet of the injection mold so that plastic material is not pressed out of the mold adjacent to the electrical conductor at its outlet location during injection molding due to the high injection pressure. This makes for an unpleasant optical appearance of the finished injection molded element and the protruding plastic lobes subsequently have to be removed in complex operations, typically by hand.

### DETAILED DESCRIPTION OF THE INVENTION

a.) Technical Task

It is therefore the technical task of the invention to provide an injection molded element and a method for producing the element, wherein the element is producible in a simple and repeatable manner in spite of the conductors being run out without causing a risk of damaging the insulation of the electrical conductor and without a risk of plastic material exiting from the injection mold at the outlet location of the cable.

b.) Solution

The technical task is solved by the features of claims 1 and 18. Advantageous embodiments can be derived from the dependent claims.

This object is achieved for the injection molded element according to the invention by molding the injection molded element onto an inner element and enveloping the cross section of the inner element advantageously from all sides, wherein the electrical conductor is inserted in the inner element.

This electrical conductor therefore is not encased by the inner element through injection molding, but there is a prefabricated inner element which includes a respective cavity into which the conductor is inserted. This electrical conductor leaves the inner element at least at one conductor outlet and the inner element protrudes from the injection molded element at least with this conductor outlet and/or the conductor is completely enveloped by the inner element in a cross sectional view.

As a matter of principle it is irrelevant, how the inner element is configured as long as it is possible to introduce the electrical conductor into the prefabricated inner element.

Preferably, the inner element is therefore made from two separate half shells or two half shells that are connected with one another through a film hinge, wherein the half-shells are placed against one another and can be interlocked with one another through respective snap locking devices after the electrical conductor is inserted.

Thus, the injection mold does not have to be sealed for the outer injection molded element relative to the electrical conductor at the conductor outlet, but the injection mold only has to be sealed relative to the outer circumference of the inner element protruding out of the injection mold. The inner element can be easily configured in cross sectional direction stable enough at least at this outlet location from the injection molded element, so that no injection molded material can exit between the injection mold and the inner element. For this purpose, the inner element is preferably configured stable enough at the outlet location so that it does not have to be supported at the interior electrical conductor that is run out at this location.

The inner element can certainly also protrude from the injection molded element at locations where no electrical conductor exits.

Also the problem of starting to melt the electrical insulation of the electrical conductor can be solved by this method since the material that is injected when producing the injection molded element does not contact the electrical conductor anywhere in its liquid state when the inner element surrounds the electrical conductor tightly at all locations.

However, it is quite feasible to provide pass through openings through the wall of the inner element, wherein the injection molded material can penetrate through the pass through openings into the inner cavity of the inner element and thus towards the electrical conductor.

This provides on the one hand side a mechanically improved connection between the injection molded element and the inner element, on the other hand side, it can be determined through the size and number of the pass through openings how quickly the injection molded material can penetrate towards the electrical conductor.

Namely when the pass through openings are correspondingly small, the injection molded material already cools down far enough on the way through the small pass through openings so that a partial melting of the insulation of the electrical conductor need not be anticipated anymore because the temperature of the injection molded material has already decreased and/or the mass of injection molded material that reaches the electrical conductor is small enough so that the amount of heat contained therein hardly suffices for partial melting of the insulation anymore.

The diameter of the pass through openings is therefore between 0.8 mm and 1.5 mm and/or between 1.0 times and 3.0 times the diameter of the passage in a transversal wall.

In case such pass through openings are provided in the walls, they certainly do not have to be provided in the end portion of the inner cavity towards the free ends of the inner element, in particular the free end through which a cable exits, since injection molded material could otherwise in turn exit from the mold in axial direction along the electrical conductor.

Therefore, preferably when pass through openings are provided in the walls of the inner element, a transversal wall is respectively provided in the inner element offset backward from the free end and no pass through opening is provided anymore in the wall of the inner element in the portion in the longitudinal direction outside of the transversal walls.

The distance of the transversal wall from the conduit outlet thus amounts to at least 15 mm, better at least 20 mm and/or in relation to the largest extension of the cross section of the pass through in the transversal wall at least 20 times, better at least 30 times the amount of this largest cross sectional extension.

The inner cavity between the transversal walls can furthermore be subdivided by additional intermediary walls into plural individual cavities, on the one hand side in order to be able to separately control the inflow of material into these cavities in case of pass through openings, in particular, however, in order to arrange respective pass through openings in the intermediary walls into which the electrical conductor is inserted and through which the electrical conductor is positioned. These pass through openings advantageously have slightly undercut cross sections so that the electrical conductor inserted therein interlocks therein.

In an elbowed injection molded element, an intermediary wall of this type is provided at least in the portion of the elbow.

For an inner element made from two half-shells and two electrical conductors that are run out an electrical conductor is advantageously inserted into each of the half-shells.

The inner element is advantageously structured three dimensionally also on its outside and includes for example outward bulges or inward indentations which help interlocking with the surrounding injection molded element.

The positioning of the inner element in the injection mold is provided in a form-locking manner, for example in that dead hole indentations are provided in the outer surface of the inner element, wherein positioning protrusions of the injection mold for the injection molded element engage so that the inner element is positioned in the injection mold.

The inner element is advantageously made from a material with a melting point that is higher than the melting point of the injection molded element so that a partial melting of the inner element does not occur during injection molding of the injection molded element.

In order to increase stability of the injection molded element, an additional stiffener, in particular made from metal, can be provided in the injection molded element together with the inner element and can be encased together with the inner element.

An injection molded element of this type is viable for different applications, for example as a plug at an end of an electrical cable.

For other applications it can be useful to produce the injection molded element and the inner element from a transparent material, but to cover the inner element in some portions with a light permeable coating and to provide an electrical illuminant at the electrical conductor, e.g. a LED at the remaining light permeable portions of the inner element.

The technical task recited supra is solved by a method including initially separately producing the inner element, for example also through injection molding and subsequently enveloping the electrical conductor with the prefabricated inner element so that the conductor exits the inner element at least at one conductor outlet.

Subsequently, the inner element with the inserted electrical conductor is inserted into the injection mold for the injection molded element, so that the inner element protrudes at least with the conductor outlet from the injection mold, so that the injection mold only has to seal relative to the inner element and not directly relative to the electrical conductor. In this condition, the inner element is encased with the injection molded element through injection molding.

When the inner element is made from two half-shells, one or plural electrical conductors are inserted into the inner cavity, in particular of the two half-shells and the two half-shells are then placed against one another and in particular interlocked with one another so that a stable unit is provided that is easy to handle. If two electrical conductors are required in this case, which is typical, an electrical conductor is inserted into each half-shell.

If desired, this allows the liquid plastic material to penetrate the inner cavity of the inner element when encasing the inner element with the injection molded element, in particular through respective arrangement and sizing of at least one pass through opening in the wall of the inner element.

In order to position the inner element in the injection mold in a form-locking manner and to prevent a sliding of the inner element when injection molding the injection molded element, the inner element is advantageously placed onto positioning protrusions of the injection mold with dead holes in its outside.

c.) Embodiments

Embodiments according to the invention are subsequently described in more detail with reference to drawing figures, wherein:

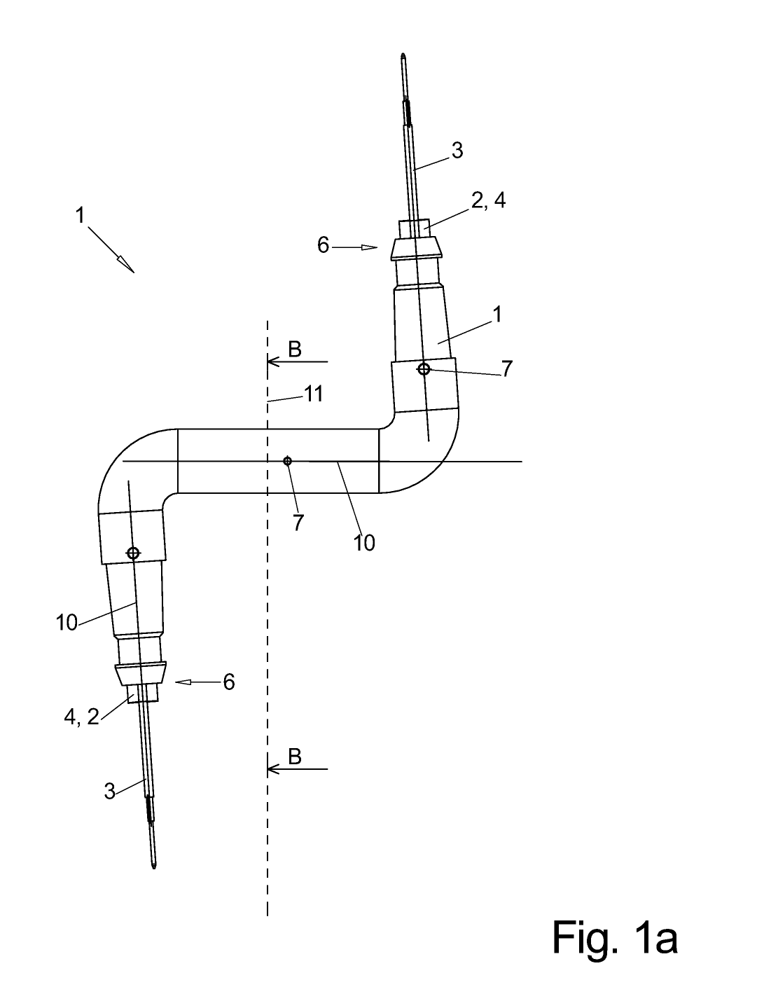

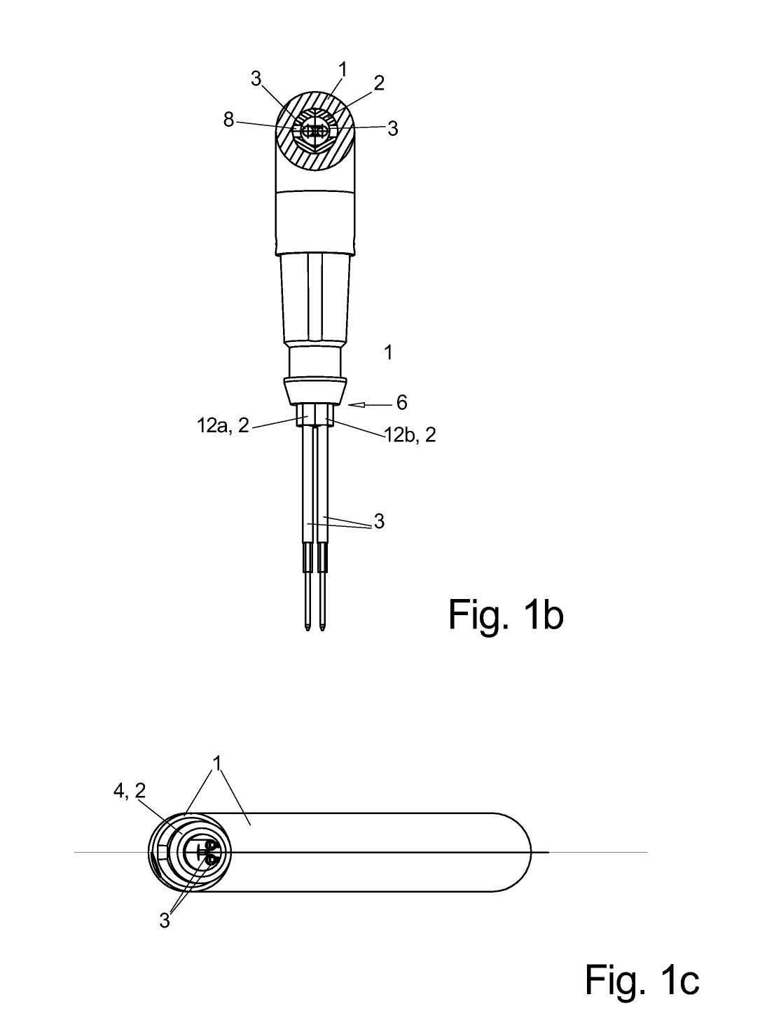

FIGS. 1a)-c) illustrate the finished injection molded element in various views and in a partial sectional view,

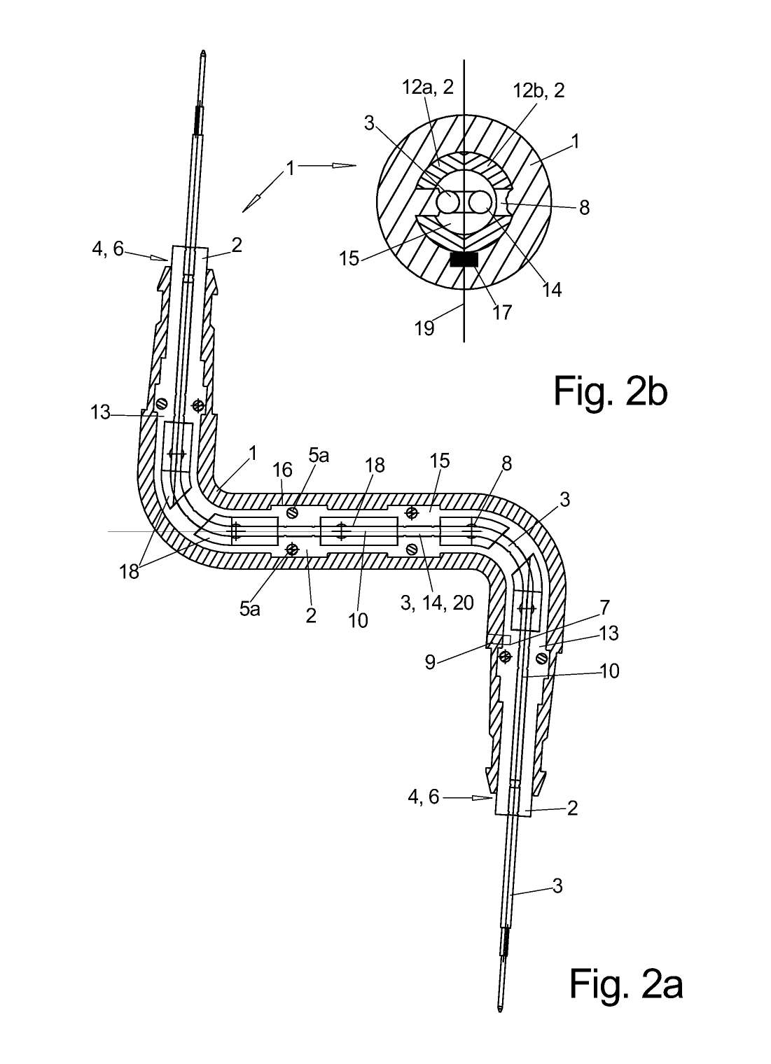

FIGS. 2a), b) illustrate the finished injection molded element in a longitudinal sectional view and in an enlarged cross sectional view,

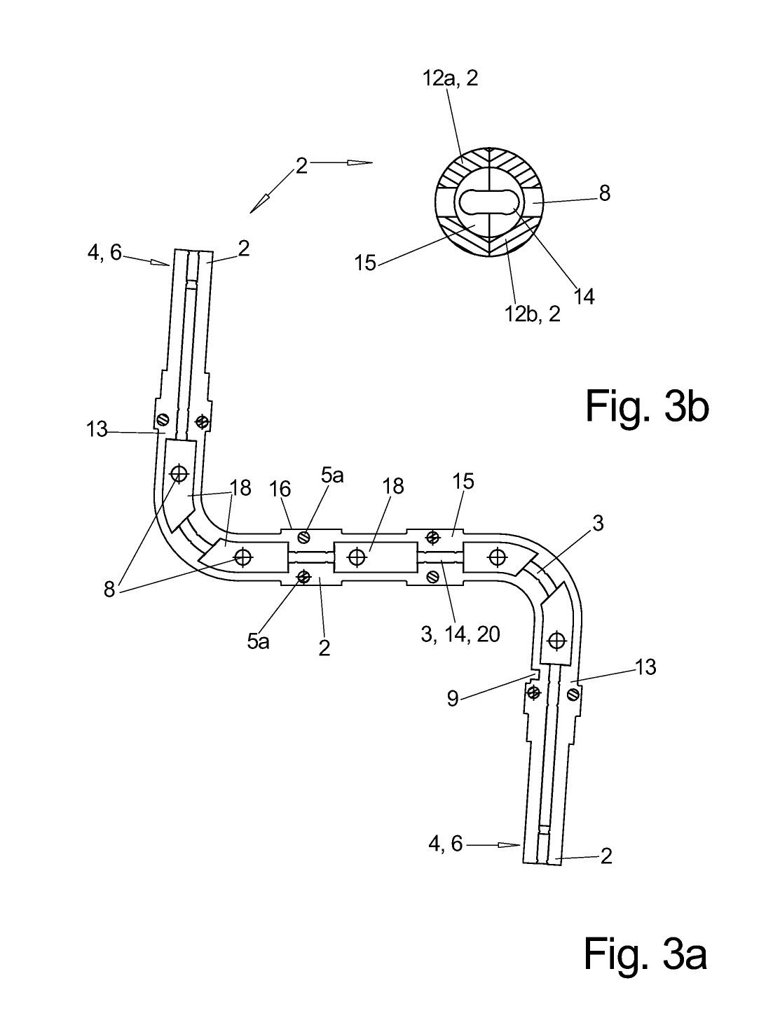

FIG. 3a) illustrate a half-shell of the inner element in a top view, and

FIG. 3b) illustrates an enlarged cross sectional view of the inner element.

FIG. 1a illustrates the finished injection molded element 1 which in this case has an elongated Z-shaped overall contour, wherein the reference numeral 10 designates the extension of the elongated injection molded element 1.

An electrical conductor 3 respectively extends from the injection molded element at both ends, wherein the electrical conductor extends all through the entire injection molded element 1 in its interior.

The injection molded element 1 is contoured user-defined on its outside according to the intended application.

As apparent from FIG. 1b and FIG. 1c, two electrical conductors 3 exit in the present case from each end of the injection molded element 1. It is further apparent that an inner element 2 protrudes from the respective free face end of the outer injection molded element 1 at the outlet location 6, wherein the inner element is made from two half-shells 12a, b.

These figures already illustrate the first advantage of the invention, wherein namely the injection mold not illustrated in FIGS. 1 a-c does not have to seal directly relative to the electrical conductors 3 when producing the injection molded element 1, but only has to seal relative to the outer circumference of the inner element 2 subsequently exiting from the injection molded element at the outlet location 6, wherein the inner element 2 is much more stable in cross sectional direction and not as elastic as the electrical conductors 3.

In the longitudinal sectional view of FIG. 2a and in the cross sectional view of FIG. 2b through the injection molded element 1, it is further apparent that the inner element 2 extends in longitudinal direction, thus in the extension 10 in the interior along the entire outer injection molded element 1 and protrudes on both sides form the injection molded element 1 and the inner element 2 is completely enveloped in circumferential direction, thus in cross sectional view by the outer injection molded element 1.

The four dead hole indentations 7 in the outer surface of the injection molded element 1 form an exception, wherein the dead hole indentations extend to a depth reaching the prefabricated inner element 2 and are used for positioning the inner element in the injection mold for the outer injection molded element 1 during the injection molding process.

These dead hole indentations 7 are created by positioning protrusions 9 which protrude in inward direction from an inner surface of the non-illustrated injection mold and contact the inner element 2 and preferably position it in a form-locking manner, for example in that an additional positioning recess is provided in this portion in the outer surface of the inner element 2, wherein the positioning protrusion 9 of the injection mold which can also be configured retractable with respect to the injection mold protrudes in a form-locking manner into the outer surface of the inner element.

The longitudinal sectional view of FIG. 2a illustrates on the other hand side that the outer surface of the inner element 2 has in particular an annular circumferential contour, thus includes protruding and recessed portions, in particular to facilitate a connection and interlocking with the injection molded element 1 that is integrally molded on the outside in order to achieve high mechanical stability.

The mechanical stability can be further improved in that a stiffener 17 configured e.g. as flat metal material is inserted and encased through injection molding together with the prefabricated injection molded element 2 in the injection mold for the outer injection molded element 1 as apparent from the cross sectional view in FIG. 2b.

It is furthermore apparent that the inner element 2 includes an inner cavity 20, which in this case extends through an entire length of the inner element 2 in longitudinal direction 10 like the electrical conductor 3 but is completely or at least essentially enveloped by the wall of the inner element 2 in a cross sectional view in circumferential direction as apparent in the individual illustration of the inner element 2 in FIG. 3b and in FIG. 3a.

This inner cavity 20 is used for housing the one or plural electrical conductors 3 and has to be sufficiently sized for this purpose. In case the electrical conductor penetrates the inner element 2 only over part of its extension, the inner cavity 20 only has to be provided in this portion in which the electrical conductors 3 are provided.

As apparent from FIGS. 2a and 3a, the inner cavity 20 does not have constant size over its extension 10 but cavities 18 with relatively large cross sections are separated from one another in longitudinal direction by intermediary walls 15 in which the inner cavity 20 is much smaller in cross sectional view and just large enough so that the one or plural electrical conductors 3 can be placed therein.

As illustrated in particular by the cross sectional views of FIGS. 2b and 3b, the pass through 14 that is provided for this purpose in the intermediary walls 15 is small enough so that the cross section of the one or plural electrical conductors 3 just fits in.

These cross sectional views illustrate further that the inner element 2 is made from two half-shells 12a, b in the present case, wherein the two half-shells respectively extend over the entire length in the extension 10 of the inner element 2 and can be interlocked with one another after inserting the electrical conductor 3 through interlocking protrusions and accordingly configured interlocking indentations forming an interlocking device 5a, b (wherein only the interlocking devices 5a are visible in the longitudinal sectional view of FIG. 2a) in order to form a unit that includes the previously inserted electrical conductors 3 and which is easy to handle.

Since two electrical conductors 3 are provided in the present case, a passage 14 is provided respectively in the transversal walls 13 of each of the two half-shells 12a, b, wherein the passage 14 is open towards the contact plane 19 between the two half-shells 12a, b and has a slightly undercut cross section into which a respective electrical conductor 3 can just be pressed, so that it interlocks in the undercut cross section of the pass through 14 so that it is positioned in a form locking manner.

The last intermediary wall in the extension 10 is designated as transversal wall 13 and extends preferably in longitudinal direction 10 over a much greater distance than the intermediary walls 15, namely from the last cavity 18 in extension direction 10 to the face end of the inner element 2. In this entire portion, the inner cavity 20 is kept small enough so that it is filled to the highest extent possible by the electrical conductors 3 to be inserted. In case no conductors 3 are provided in an end portion, no inner cavity 20 is provided. Thus, the electrical conductors are well protected by the surrounding inner element 2 when they are inserted into the injection mold together with the inner element 2 and encased in order to produce the outer injection molded element 1.

The injection molded material reaches the inner cavity 20 of the inner element 2 when injecting the injection molded element 1 in case this is desired and thus reaches the electrical conductor 3 only when one or plural pass through openings 8 are provided in the wall of the inner element 2 as illustrated for example in FIG. 3b on the left side or in FIG. 2b on both sides of the inner element 2.

The extent to which the inner cavity 20 is filled with injected material depends on from the sizing of the pass through openings 8.

In the subdivision of the inner cavity 20 described supra into broader cavities 18 and narrower pass through openings 14 in the intermediary walls 15, the pass through openings 8 are preferably only arranged in the portion of the cavities 18.

### REFERENCE NUMERALS AND DESIGNATIONS

1 Injection molded element
2 Inner element
3 Conductor, electrical conductor
4 Conductor outlet
5a, b Interlocking device
6 Outlet location
7 Dead hole indentation
8 Pass through opening
9 Positioning protrusion
10 Longitudinal direction, extension
11 Cross sectional direction
12a, b Half-shell
13 Transversal wall
14 Passage
15 Intermediary wall
16 Bulge
17 Stiffener
18 Cavity
19 Contact plane
20 Inner cavity

1. An injection molded element (1), comprising:
at least one electrical conductor run out from the injection molded element characterized in that
the injection molded element (1) is injection molded onto an inner element (2),
a conductor (3) is inserted into the inner element (2),
the inner element (2) envelops the conductor which leaves the inner element (2) at least at one conductor outlet (4), and
the inner element (2) protrudes from the injection molded element (1) at least with the conductor outlet (4).

2. The injection molded element (1) according to claim 1, characterized in that the injection molded element (1) is made from plastic material.

3. The injection molded element (1) according to claim 1, characterized in that the inner element (2) is made from two separate half shells (12a, b) or half shells connected by a film hinge.

4. The injection molded element (1) according to claim 3, characterized in that the half shells (12a, b) include interacting interlocking devices (5a, b) and are interlocked with one another in assembled condition.

5. The injection molded element (1) according to claim 1, characterized in that the inner element (2) is configured firm enough at the outlet location (6) of the injection molded element (1) in cross sectional direction (11) so that the inner element (2) is not supported at the radially interior electrical conductor (3).

6. The injection molded element (1) according to claim 1 characterized in that at least a portion of the conductor outlet (4) is separated from a rest of an inner cavity (20) of the inner element (2) through a transversal wall (13) in the inner element (2), and a passage (14) is provided in the transversal wall (13), wherein the passage is just large enough so that it can receive the at least one electrical conductor (3) with a tight fit and the passage (14) has, in particular, an undercut cross section.

7. The injection molded element (1) according to claim 6 characterized in that
the inner element (2) has dead hole indentations (7) on its outside for applying positioning protrusions (9) of the injection mold and/or
the inner element (2) has pass through openings (8) from its outside towards its inside for a penetration of an injection molding material for the injection molded element (1) into an interior of the inner element (2), however not in a portion outside of the transversal wall (13).

8. The injection molded element (1) according to claim 6, characterized in that a distance of the transversal wall (13) from the conductor outlet (4) from the inner element (2) is at least 20 mm.

9. The injection molded element (1) according to claim 6 characterized in that a distance of the transversal wall (13) from the conductor outlet (4) from the inner element (2) is at least 20 times; better at least 30 times, the greatest cross sectional extension of the pass through opening in the transversal wall (13).

10. The injection molded element (1) according to claim 6 characterized in that
the inner cavity (20) between the respective last transversal walls (13) is divided into individual cavities by additional intermediary walls (15) and pass through openings (8) for at least one electrical conductor (3) are provided in the intermediary walls (15) and a pass through opening (8) is provided in particular in each cavity,
the inner element (2) and the injection molded element (1) are made from the same material.

11. The injection molded element (1) according to claim 10 characterized in that the inner element (2) includes an outward bulge (16) in the portion of the transversal walls (13) and/or of the intermediary walls (15).

12. The injection molded element (1) according to claim 10, characterized in that the diameter of the pass through opening (8) is between 0.8 mm and 1.5 mm and/or—the diameter of the pass through opening (8) is between 1.0 times and 3 times the diameter of the pass through opening (14) in the transversal wall (13).

13. The injection molded element (1) according to claim 1, characterized in that the inner element (2) is made from a material whose melting point is higher than an injection temperature of the material of the injection molded element (1).

14. The injection molded element (1) according to claim 1 characterized in that a stiffener (17), made from metal, is arranged in the injection molded element (1) parallel to the inner element (2).

15. The injection molded element (1) according to claim 1, characterized in that the inner element (2) of an injection molded element with an elbow includes an intermediary wall in the portion of the elbow.

16. The injection molded element (1) according to claim 1, characterized in that the injection molded element (1) is a plug.

17. The injection molded element (1) according to claim 1 characterized in that the injection molded element (1) is made from a transparent material and the inner element (2) is made from a transparent material which is covered in portions by a light impermeable coating, in particular a lacquer and in particular an electrical illuminant, in particular a LED is arranged in the interior of the inner element (2).

18. The method for producing an injection molded dement (1) with at least one electrical conductor (3) run out comprising:
an inner element (2) is produced, in particular through injection molding,
the electrical conductor (3) is encased with the prefabricated inner element (2) so that the conductor (3) exits the inner element (2) at least at one conductor outlet (4),
the inner element (2) with the electrical conductor (3) is inserted into an injection mold so that the inner element (2) protrudes from the injection mold at least with the conductor outlet (4), and
the inner element (2) is encased with the injection molded element (1).

19. The method according to claim 18, characterized in that the electric conductor (3) is inserted in the hollow cavity of the prefabricated inner element (2) and in particular the two half-shells (12a, b) of the inner element (2) are placed against one another and in particular interlocked with one another.

20. The method according to claim 18, characterized in that for two electrical conductors (3) and one inner element (2) made from two half shells (12a, b) an electrical conductor is inserted into each half-shell and in particular interlocked.

21. The method according to claim 18, characterized in that liquid plastic material is capable to penetrate the cavity of the inner element when the inner element is encased with the injection molded element (1).

22. The method according to claim 18, characterized in that the inner element (2) is positioned in a form-locking manner in the injection mold, in particular the inner element (2) is placed with its dead hole openings (7) in its outside on positioning protrusions of the injection mold.
